(19) United States
(12) Patent Application Publication
(10) Pub. No.: US 2025/0339815 A1
(43) Pub. Date: Nov. 6, 2025

(54) CO2 SORPTION WITH OXIDATION RESISTANT AMINES

(71) Applicant: EXXONMOBIL TECHNOLOGY AND ENGINEERING COMPANY, Spring, TX (US)

(72) Inventors: Simon C. WESTON, Easton, PA (US); Aaron W. Peters, New Hope, PA (US); Hilda B. Vroman, Piscataway, NJ (US)

(21) Appl. No.: 19/265,620

(22) Filed: Jul. 10, 2025

Related U.S. Application Data
(63) Continuation of application No. PCT/US2024/011357, filed on Jan. 12, 2024.
(60) Provisional application No. 63/480,407, filed on Jan. 18, 2023.

(51) Int. Cl. B01D 53/62; B01D 53/02; B01D 53/14

(52) U.S. Cl. CPC B01D 53/62; B01D 53/02; B01D 53/1475; B01D 2252/20421; B01D 2252/20426; B01D 2253/204; B01D 2257/504; B01D 2259/10

(57) ABSTRACT

Systems and methods are provided for using oxidation-resistant amines in cyclic and/or regenerable CO₂ capture environments. The oxidation-resistant amines correspond to amines that are partially or fully substituted on the β-carbon relative to the amine. By using oxidation-resistant amines, difficulties associated with amine degradation in the presence of oxygen at elevated temperatures can be reduced or minimized. This can allow for sorption/desorption cycles with improved efficiency, resulting in lower operational costs for a CO₂ capture system.

### CROSS-REFERENCE TO RELATED APPLICATIONS

This application is a Continuation of PCT/US2024/011357, filed Jan. 12, 2024, and titled “CO2 SORPTION WITH OXIDATION RESISTANT AMINES”, which claims the benefit of priority to U.S. Provisional Patent Application No. 63/480,407 filed Jan. 18, 2023, and titled “CO2 SORPTION WITH OXIDATION RESISTANT AMINES”, both of which are incorporated herein by reference in their entirety.

### FIELD

Methods are provided for performing sorption of CO₂ with oxidation resistant amines.

### BACKGROUND

Mitigation of CO₂ emissions and/or concentrations from various types of CO₂ sources (industrial, small-scale, and direct air capture) is an area of ongoing interest. One type of strategy for mitigation of CO₂ emissions is to use an adsorbent or absorbent to remove CO₂ from a potential emission gas flow, and then desorb the CO₂ as part of a stream that can be processed to reduce, minimize, or eliminate the release of CO₂ into the atmosphere.

For applications where sorption (adsorption or absorption) of CO₂ is desired, amines are commonly used as the sorbent. One example of a potential sorbent configuration is to use an amine sorbent that is supported on some type of structural material. This type of configuration can be convenient for exposure of gas phase sources of CO₂ (such as air or combustion flue gases) to the amine sorbent.

Unfortunately, the sorption/desorption cycles used for CO₂ capture using supported amine sorbents can tend to have high operational costs. The elevated operational costs are due in part to the potential for degradation of supported amine sorbents when exposed to air or flue gas at elevated temperatures. This poses a problem for commercial scale sorption/desorption processes, where it is often desirable to use elevated temperatures for desorption of CO₂ during the desorption phase of the process cycle. Due to the potential for amine degradation, conventional processes avoid use of air as a heat transfer fluid during and/or after the desorption phase, so that the amine sorbent is not exposed to air or flue gases at temperatures greater than 70° C. Instead, cycles are designed so that a different heat transfer fluid is used to cool a heated sorbent environment prior to any air exposure and/or cycles are designed to completely remove air prior to heating the sorbent environment. Using a separate heat transfer fluid and/or other additional process steps result in substantially higher operational costs for the sorption/desorption cycle. What is needed are systems and/or methods that can allow for reduced cost operation of a sorption/desorption cycle for CO₂ capture.

Jones et al. showed that impregnation of PEI (polyethyleneimine, a polymeric amine) onto alumina showed poor oxidative stability at 110° C. after only 20 hours of exposure to humid gas containing 21% O₂, losing 70% of the CO₂ capacity. (Energy & Fuels (2013), Vol. 27, pages 1547-1554.) Reducing the temperature to 70° C. reduced the loss to 35%. At a lower 5% O₂ concentration as might be seen in some flue gases, a loss of 7.5% CO₂ capacity after 20 hours at 110° C. and a 1.4% loss after 20 hours at 70° C. was observed.

Sayari et al. studied various propylamines grafted onto pore-expanded MCM-41 silica after brief exposure to air at several temperatures. (Microporous and Mesoporous Materials (2011), Vol 145, pages 146-149.) At 120° C., secondary amines were less stable than primary and tertiary amines after treatment with flowing air at 120° C. for 30-40 hours but they all showed significant degradation over the short exposure time. Below 120° C. the primary amine showed no loss in CO₂ capacity while at 120° C. it showed a 7.5% loss in CO₂ capacity. The secondary amine lost 5.3% CO₂ capacity at 90° C., 32% at 120° C. (both 30 hour exposures) and 86% at 140° C. (40 hour exposure). Additionally, the triamine TRI which is a mixture of primary and secondary amines fared even worse losing 5%, 47% and 94% of its CO₂ capacity after exposures for 30 hours at 70° C., 90° C. and 120° C., respectively.

U.S. Patent Application Publication 2021/0129071 describes CO₂ sorbent materials corresponding to metal organic framework materials that are appended with substituted 1,3-propanediamines.

U.S. Pat. No. 11,103,826 describes systems and methods for CO₂ sorption and desorption using amines with Type V isotherms. One example shown in the patent is sorption and desorption of CO₂ from gas streams with various CO₂ concentrations using 2,2-dimethylpropane-1,3,-diamine (dmpn) as the amine sorbent.

Examples of porous liquids and porous liquid contactors are described in U.S. Patent Application Publication 2020/0147543, U.S. Patent Application Publication 2020/0147545, and U.S. Patent Application Publication 2020/0147519.

U.S. Pat. No. 8,658,041 describes examples of hollow fiber contactor structures. In the contactor structures, a hollow fiber can include adsorbents in the polymeric material and can further include a barrier layer to prevent fluid exchange between the polymeric material and the central bore.

U.S. Patent Application Publication 2021/0040343 describes methods for using ternary ink compositions including a polymer, a solvent, and a non-solvent for solvent based additive manufacturing. During three-dimensional printing, after depositing a layer of ink, the polymeric structure is formed by phase inversion after evaporation of a portion of the solvent from the ink.

U.S. Pat. No. 9,011,583 describes a monolith type structure containing a plurality of fluid flow channels. The monolith can be used as part of the adsorbent contactor. During operation, a separate cap or top structure can be placed on top of the monolith to block entry of process gas to selected channels. The selected channels can then be used for transport of a heat transfer fluid during operation. The top structure also assists with defining a header for introducing the heat transfer fluid into the selected channels in the monolith without introducing the heat transfer fluid into the channels containing the process gas flow. This can be achieved in part by removing walls from some of the selected channels, so that the selected channels are in fluid communication in the header area defined by the combination of the monolith and the top structure. The selected channels can also include a coating to prevent heat transfer fluid from leaving the selected channels.

U.S. Pat. No. 9,968,882 describes methods of using heat transfer fluids in direct contact with a sorbent to assist with managing temperature during a sorption/desorption cycle.

U.S. Patent Application 63/191,715 describes examples of hollow fiber contactor structures that include metal organic framework materials, including amine-appended metal organic framework materials.

U.S. Patent Application 63/195,310 describes examples of ink formulations for forming 3-D printed contactor structures that incorporate metal organic framework materials, including amine-appended metal organic framework materials.

International Publication WO 2020/219907 describes synthesis and use of EMM-67.

### SUMMARY

In an aspect, a method for performing cyclic sorption and desorption of CO₂ is provided. The method includes contacting an amine-based sorbent with a CO₂-containing input flow to form a CO₂-loaded sorbent and a sorption output flow with a CO₂ content lower than the CO₂-containing input flow. The amine-based sorbent can correspond to one or more amines that are substituted at the β-carbon. The method further includes desorbing CO₂ from the sorbent by exposing the CO₂-loaded sorbent to a desorption input flow to form a CO₂-depleted sorbent and a desorption output flow with a CO₂ content greater than the desorption input flow. A temperature of the desorption output flow at the end of the desorbing can be 80° C. or higher. Additionally, the method includes adjusting the temperature of the sorbent by exposing the sorbent to a temperature adjustment flow containing 8.0 vol % or more of O₂ to form a regenerated sorbent and an adjustment output flow. A temperature of the adjustment output flow at an end of the adjusting can be lower than the temperature at the end of the desorbing by 20° C. or more.

### BRIEF DESCRIPTION OF THE DRAWINGS

FIG. 1 shows examples of amines.

FIG. 2 shows examples of additional amines.

### DETAILED DESCRIPTION

All numerical values within the detailed description and the claims herein are modified by “about” or “approximately” the indicated value, and take into account experimental error and variations that would be expected by a person having ordinary skill in the art.

### Overview

In various aspects, systems and methods are provided for using oxidation-resistant amines in cyclic and/or regenerable CO₂ capture environments. In some aspects, the oxidation-resistant amines correspond to amines that are partially or fully substituted on the β-carbon relative to the amine. In some aspects, the oxidation-resistant amines correspond to amines that have replacement substitution of the β-carbon, so that an atom different from carbon is present in the “beta” location. By using oxidation-resistant amines, difficulties associated with amine degradation in the presence of oxygen at elevated temperatures can be reduced or minimized. This can allow for sorption/desorption cycles with improved efficiency, resulting in lower operational costs for a CO₂ capture system.

CO₂ capture typically involves a cyclic process so that CO₂ can be adsorbed/absorbed by a sorbent followed by desorption of CO₂ from the sorbent (regeneration). A variety of amine-based sorbents can be used in a CO₂ capture process, including but not limited to, sorbents supported on a substrate or support; sorbents appended to a structure, such as amines appended to a zeotype and/or a metal organic framework material; polymeric structures where a portion of the polymeric repeat units contain amines and/or the polymeric matrix contains amine-containing materials; or a porous liquid.

While the properties of the sorption isotherm/isobar of a sorbent material are important for having an effective sorption/desorption cycle, a number of other factors also impact the process. Some factors are related to the need to manage temperature during the cycle, so that the sorbent is in a (lower) target range of temperatures during sorption and a (higher) second target range of temperatures during desorption. For example, U.S. Pat. No. 9,968,882 describes methods of using heat transfer fluids in direct contact with a sorbent to assist with managing temperature during a sorption/desorption cycle. Other factors can be related to managing the flows into and through the sorbent material so that CO₂ lost to the environment is reduced or minimized.

When managing the factors related to temperature control and reduction of CO₂ loss, an additional consideration is reducing or minimizing degradation of the amine-based sorbent material. Conventionally, it is believed that when amines are exposed to environments where sufficiently high combinations of O₂ concentration and temperature are present, such as exposure to air or flue gases containing O₂ at temperatures of 70° C. or higher, the sorption capacity of the amine can be degraded. This can result in lower capacity and/or less favorable sorption/desorption characteristics for the degraded amine-based sorbent structures.

As an example, during a conventional sorption/desorption cycle for removing CO₂ from a flue gas using an amine-based sorbent, a first step can be to adsorb/absorb CO₂ by contacting the sorbent with a CO₂-containing gas flow at a sorption temperature. At the end of the sorption step, the flow of CO₂-containing gas is stopped. The temperature of the sorbent then needs to be raised to the desorption temperature. This can be accomplished, for example, using steam. The steam can also serve as a carrier gas for removing CO₂ that desorbs from the sorbent. After the desorption step is complete, the temperature of the sorbent needs to be returned to the sorption temperature, which is typically accomplished by exposing the sorbent to a gas as a heat transfer fluid. This can pose a problem, however, as the temperature throughout the sorbent at the end of the desorption step is typically 100° C. or higher. At this temperature, it is conventionally believed that exposure of an amine-based sorbent to a high concentration of oxygen, such as 8.0 vol % or more, or 10 vol % or more, or 15 vol % or more, will result in degradation of the sorbent. Thus, it is believed that air cannot be used as the heat transfer fluid, since air typically has an oxygen content of roughly 21 vol %. Although flue gases typically have a lower O₂ concentration (such as around 12 vol % O₂), such an oxygen concentration would still be unfavorable. However, even if a flue gas had a substantially lower O₂ concentration, the flue gas still could not be used as the heat transfer fluid because the sorbent is initially at the desorption temperature. Until the sorbent environment is cooled, passing the flue gas through the sorbent environment would result in excess loss of CO₂ to the environment, as the sorbent will have little or no ability to sorb the CO₂ in the flue gas until the sorbent is sufficiently cooled. Additionally, if the sorbent has a Type I isotherm for CO₂ sorption, some CO₂ may remain on the sorbent after the desorption step. If a flue gas was used as a cooling gas, additional CO₂ desorption could potentially occur during cooling, resulting in a reduction in the percentage of CO₂ that is effectively captured.

As another example, some types of sorbents have a sufficiently large enthalpy of adsorption for CO₂ that heating of the sorbent bed can become an issue during a sorption step. For example, some types of amine-appended metal organic framework (MOF) sorbents can have substantially higher enthalpies of adsorption than conventional sorbents such as zeolites or carbons. Due to this higher enthalpy of adsorption, if such a sorbent is used for CO₂ sorption from a flue gas stream with a CO₂ content of greater than 1.0 vol %, sufficient heat may be generated that the sorbent bed can increase in temperature to above 70° C. Various types of cooling can be used to reduce or mitigate this temperature increase, but this illustrates that amine degradation can potentially pose a problem even during the sorption step itself for flue gases with sufficient CO₂ and O₂ content.

Due to these difficulties, nitrogen is often used as the heat transfer fluid in laboratory settings to cool the sorbent/sorbent environment after the desorption step is complete. However, this is not desirable on a commercial scale, in part because some CO₂ can still desorb from the sorbent during such a cooling step. Using nitrogen can result in effectively making a new flue gas, thus undoing the separation that was just performed. As a result, for a system intended for commercial use, at least a portion of the cooling can instead performed by reducing the pressure in the sorbent environment to less than 100 kPa-a. In addition to cooling from withdrawing gas from the sorbent environment, any water sorbed by the sorbent can also evaporate, providing further cooling. It is noted that at reduced pressures, steam can be maintained as a gas at temperatures below 100° C. Thus, steam can also be introduced into such a reduced pressure environment for further cooling of the bed.

It is noted that previously sequestered CO₂ could also be used as a heat transfer fluid. However, this would still incur operating costs for maintaining a high purity CO₂ reservoir. Also, substantial additional process and equipment complexity would be required to allow CO₂ to be used as a heat transfer fluid without incurring excess CO₂ losses to the environment.

Sorption/desorption cycles for performing direct air capture can have additional difficulties. For direct air capture, air is the CO₂-containing gas. After the desorption step, it would be desirable to be able to use air as the heat transfer fluid, as that would allow the “heat transfer step” to simply be an initial part of the sorption step in the cycle. However, based on conventional understanding, the need to avoid introduction of air into the sorbent environment at elevated temperatures means that a pressure reduction step and/or a separate heat transfer fluid is needed to perform direct air capture.

In addition to temperature adjustment after the end of the desorption step, direct air capture processes can also have difficulties with heating the sorbent after the sorption step and prior to the desorption step. After performing a sorption step during direct air capture, the sorbent is typically at a temperature between 0° C. to 50° C. This is due in part to the relatively low concentration of CO₂ in air, so that filling up the adsorbent to full capacity during direct air capture occurs relatively slowly regardless of the sorbent. As a result, the heat capacity of air during direct air capture is typically sufficient to transport away substantial portions of the heat generated during sorption of the low concentrations of CO₂ present in air. In order to perform the desorption step, the sorbent/sorbent environment needs to be heated to a higher temperature, such as a temperature of 80° C. or more, or 100° C. or more. However, at the end of the sorption step, the sorbent environment is filled with air. So far, conventional options for solving this problem have been unsatisfactory. The typical conventional solution is to introduce steam (for increasing the temperature) and simply hope that the oxygen in the environment is purged by the steam before too much degradation occurs. One way to avoid this conventional solution would be to use a cold purge gas (such as N₂) after the sorption step in order to remove air from the sorbent environment prior to using steam to heat the environment. Another way to avoid the conventional solution could be to evacuate the sorbent environment to a sufficiently low pressure. Either of these options, however, requires additional operating costs and loss of sorbent productivity due to the extra cycle time required.

It has been discovered that amines that are substituted at the β-carbon can have unexpectedly high resistance to degradation. Based on the IUPAC definition, an amine is a compound that can be formally derived by starting with the structure of ammonia and replacing one, two, or three of the hydrogen atoms with hydrocarbyl groups. In an amine, the carbon atom that is directly bonded to the nitrogen atom corresponds to the “alpha” carbon, or α-carbon. A carbon bonded to the alpha carbon (but not bonded to the same nitrogen) corresponds to a “beta” carbon, or β-carbon.

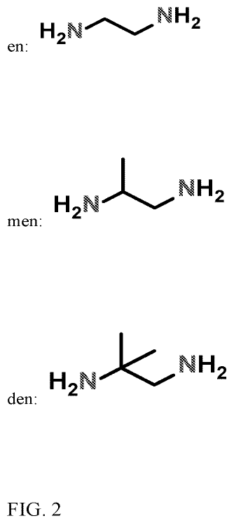

There are two possible ways to have substitution at the β-position. One type of substitution is to have a carbon at the “beta” position, but to have some type of substitution on the β-carbon. This is referred to herein as substitution on the β-carbon. It has been discovered that amines where the β-carbon is fully substituted (i.e., has no bonds to hydrogen atoms) have an unexpectedly high resistance to degradation when exposed to an environment containing 8.0 vol % or more of O₂, or 10 vol % or more, or 15 vol % or more at a temperature of 70° C. or more, or 85° C. or more, or 100° C. or more, or 110° C. or more, such as up to 180° C. or possibly still higher. Additionally, amines where the β-carbon is partially substituted (i.e., bonds to at least three atoms different from hydrogen) can have increased resistance to degradation when exposed to 8.0 vol % or more of O₂ at elevated temperatures. This is in contrast to an unsubstituted β-carbon, which has two bonds to hydrogen atoms. It is noted that for unsubstituted ethylene diamine-type structures, the carbon atoms of the ethyl group will have one bond to a carbon atom, one bond to a nitrogen atom, and two bonds to hydrogen atoms. (See FIG. 2 described below.) It is further noted that one or more of the atoms bonded to a fully-substituted or partially-substituted β-carbon may be different from carbon or nitrogen, such as an oxygen or a halogen. It is further noted that the definition for a partially substituted β-carbon includes the situation where the β-carbon is part of an olefin and has no bonds to hydrogen atoms.

The other type of substitution is to have an atom different from a carbon atom at the “beta” position in a compound. This is referred to herein as replacement substitution of the β-carbon. As an example of replacement substitution of the β-carbon, the atom at the “beta” position in a molecule can correspond to an oxygen or a nitrogen. Without being bound by any particular theory, it is believed that degradation of amines occurs due in part to a reaction mechanism that involves carbon atoms bonded with one or more hydrogen atoms at the “beta” position in the amine compound. If an amine is used where the atom at the “beta” position is not a carbon, degradation reactions that involve a carbon atom at the “beta” position cannot occur. It is believed that this type of substitution can provide at least a portion of the benefits that were unexpectedly observed due to substitution on a β-carbon. Thus, the phrases “substitution at the β-carbon” or a “substituted β-carbon” are defined herein to include both “substitution on the β-carbon” and “replacement substitution of the β-carbon”.

It is further noted that the number of carbon atoms between nitrogens in an amine can have an impact on stability. The typical amines used for carbon captures contain multiple amine functionalities. Without being bound by any particular theory, it is believed that amines having two carbon atoms between amine functionalities (such as ethylene diamine) have lower resistance to degradation than amines with three carbon atoms between amine functionalities (such as propylene diamine). This may be due in part to ethyldiamines having a greater number of hydrogens on β-carbons that propyldiamines. Additionally or alternately, this may be due in part to the higher tendency for ethyldiamines to form olefins and/or ring structures via hydrogen elimination. It has been discovered that regardless of the type of amine structure, replacing hydrogen atoms on β-carbons with other substituents results in improved resistance to degradation.

Using a sorbent containing an amine having a fully substituted β-carbon (or optionally partially substituted, or optionally substituted by replacement) can allow for use of sorption/desorption cycles with improved efficiency and/or reduced operating costs. In various aspects, the improved efficiency and/or reduced operating costs can be achieved based on the ability to use air (or another gas with 15 vol % or more of 02) as a heat transfer fluid during a temperature adjustment step, such as after the desorption step and prior to the sorption step, or after the sorption step and prior to the desorption step.

In addition to allowing for improved sorption/desorption process cycles, use of a sorbent containing an amine having a fully substituted β-carbon (or optionally partially substituted, or optionally substituted by replacement) can also allow CO₂ capture to continue to be performed on a flue gas when unexpected changes occur in the nature of the flue gas. For example, flue gases are typically generated by a combustion environment. If something occurs in the combustion environment that causes the O₂ content of the flue gas to be higher than expected, the resulting flue gas can still be processed using a sorbent based on an amine substituted at the β-carbon with a reduced or minimized concern that the sorbent will be damaged.

### Definitions

In this discussion, the “sorbent environment” is defined as the volume within a vessel that contains the sorbent used for performing a sorption/desorption cycle. When multiple vessels are present, such as vessels arranged in parallel to allow continuous processing of a gas flow by having different portions of the sorbent in different stages of the process cycle, each vessel is defined as a separate sorbent environment. It is noted that a “vessel” can correspond to a portion of a conduit that contains the sorbent, even though the conduit does not otherwise change size upstream or downstream from the portion of the conduit that contains the sorbent.

For many types of sorbents and/or sorbent environments, a temperature gradient can be present in the sorbent/sorbent environment during a sorption/desorption process cycle. In this discussion, the temperature of the gas flow at the exit or exhaust from the sorbent environment is used as a characteristic temperature for the sorbent.

In this discussion, an amine is defined according to the IUPAC definition. In this discussion, the hydrocarbyl groups in an amine can optionally include one or more other functional groups that contain heteroatoms different from carbon or hydrogen.

In this discussion, sorption is defined as including both adsorption and absorption. Adsorption refers to physical association of a component with a surface or active site, such as physisorption of CO₂ on a solid surface. Absorption corresponds to a physical or chemical incorporation of component into a different phase, such as incorporation of gas phase CO₂ into a complex with a liquid phase amine. Desorption is defined as separation of an adsorbed or absorbed component from the adsorption surface or absorption phase.

In this discussion, surface areas of materials are defined as BET (Brunauer, Emmett, and Teller) surface areas as measured according to ASTM D3663. In this discussion, pore volumes can be determined according to ASTM D4641 (N₂ pore volume) or ASTM D4284 (Hg pore volume).

In this discussion, a zeotype is defined to refer to a crystalline material having a porous framework structure built from tetrahedra atoms connected by bridging oxygen atoms. Examples of known zeotype frameworks are given in the “Atlas of Zeolite Frameworks” published on behalf of the Structure Commission of the International Zeolite Association”, 6^{th} revised edition, Ch. Baerlocher, L. B. McCusker, D. H. Olson, eds., Elsevier, New York (2007) and the corresponding web site, http://www.iza-structure.org/databases/. Under this definition, a zeolite refers specifically to an aluminosilicate having a zeotype framework structure. Under this definition, a zeotype can refer to aluminosilicates (i.e., zeolites) having a zeotype framework structure as well as crystalline structures containing oxides of heteroatoms different from silicon and aluminum. Such heteroatoms can include any heteroatom generally known to be suitable for inclusion in a zeotype framework, such as gallium, boron, germanium, phosphorus, zinc, and/or other transition metals that can substitute for silicon and/or aluminum in a zeotype framework. It is noted that under this definition, a zeotype can include materials such as silicoaluminophosphate (SAPO) materials or aluminophosphate (AlPO) materials.

Examples of Amines with Substituted β-Carbons

In various aspects, a sorbent having an amine with a fully substituted β-carbon (or optionally a partially substituted β-carbon, or optionally replacement substituted) can be used as the sorbent for a CO₂ sorption/desorption cycle. The amine can correspond to an individual amine compound, an amine-containing polymer, an amine appended to another structure (such as an amine appended to a metal organic framework material), an amine in the form of a porous liquid, or any other convenient type of amine that includes a substituted β-carbon.

One type of commonly used amine-containing sorbent is an amine-containing polymer, such as polyethyleneimine. Typically commercially available polyethyleneimine corresponds to a mixture of primary and secondary amines, with the β-carbon sites in the polymer corresponding to unsubstituted β-carbons. In some aspects, an amine with substituted β-carbon sites can correspond to a polyethyleneimine where at least a portion of the repeat units in the polyethylene imine have substituted β-carbons. More generally, it is noted that polymeric amines (and/or other larger amines) are often mixtures of primary, secondary, and/or tertiary amines.

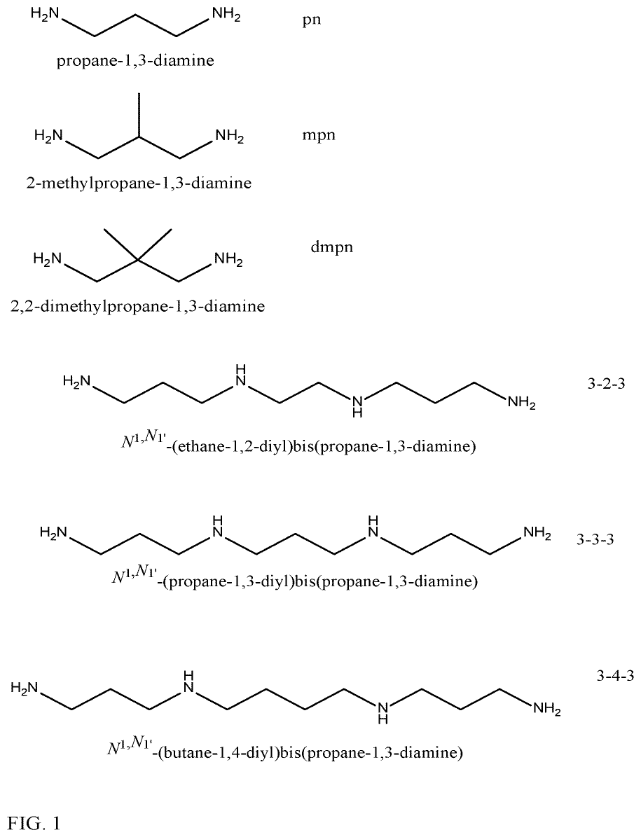

Other examples of amines can correspond to smaller compounds. FIG. 1 shows examples of six different amines with various numbers of substituents at the β-carbon location relative to the amine. The amines shown in FIG. 1 are suitable for appending to metal organic frameworks to form materials with favorable CO₂ sorption properties. In FIG. 1, the first three chemical structures correspond to propane-1,3-diamine (pn), 2-methylpropane-1,3-diamine (mpn), and 2,2-dimethylpropane-1,3-diamine (dmpn). Propane-1,3-diamine corresponds to an amine that is not substituted on the β-carbon, as there are two hydrogens attached to the β-carbon. 2-methylpropane-1,3-diamine corresponds to an amine that is partially substituted on the β-carbon. 2,2-dimethylpropane-1,3,-diamine corresponds to an amine that is fully substituted on the β-carbon. It is noted that the same carbon corresponds to the β-carbon for both of the amines in these three compounds.

The remaining structures in FIG. 1 are tetraamines, with varying chain lengths between the central two amines. The tetraamines in FIG. 1 can be referred to as 3-2-3 tetraamine, 3-3-3 tetraamine, and 3-4-3 tetraamine, based on the chain length of the central carbon chain in each compound. All of the tetraamines shown in FIG. 1 include unsubstituted β-carbons for each amine group.

The diamines shown in FIG. 1 correspond to small molecule compounds, with mpn corresponding to an amine compound that is partially substituted on the β-carbon and dmpn corresponding to an amine compound that is fully substituted on the β-carbon. In other aspects, oligomers or polymers can be used that can contain still larger numbers of amines within a single compound. Generally, any convenient number of amine functional groups can be contained in a single compound (small molecule, oligomer, polymer).

In compounds with multiple amine groups, only a portion of the amine groups may be fully substituted and/or partially substituted at the β-carbon locations. Such compounds where only a portion of the β-carbons correspond to fully and/or partially substituted β-carbons can still provide the benefits described herein, roughly in proportion to the number of fully and/or partially substituted β-carbon locations.

### Sorption and Desorption Cycle

A basic sorption/desorption cycle can have four steps. At the beginning of the cycle, a sorption step allows CO₂ to be sorbed to the sorbent by exposing the sorbent to a CO₂-containing gas flow at a sorption temperature or in a sorption temperature range. After sorption, a temperature adjustment step can be used to increase the temperature of the sorbent to the desorption temperature. Optionally, this temperature adjustment step can be performed using the same gas flow and/or at the same time as the desorption step. During desorption, CO₂ is removed from the sorbent, typically in the presence of a sweep gas to remove the CO₂ from the sorbent environment. After desorption, the sorbent is then cooled to the sorption temperature or sorption temperature range to start the cycle again. Optionally, other steps could be present as well. For example, in a direct air capture process cycle, a pressure reduction step could be inserted after sorption and prior to temperature adjustment, or a pressure reduction step could be inserted after desorption and prior to/during cooling to the target temperature for the beginning of the sorption step.

In various aspects, the benefits of using an amine-based sorbent that is substituted at one or more β-carbon locations can be realized when performing a cyclic CO₂ sorption process. The improvements in the cyclic sorption process are provided at least in part based on improvements for one or both of the temperature adjustment steps in a process cycle.

After finishing the desorption step of a sorption/desorption cycle, the sorbent (and/or the sorbent environment) is at an elevated temperature that has little or no additional capacity for sorption of CO₂. Thus, a cooling temperature adjustment step is needed to return the sorbent to a target temperature for the start of the sorption step. For example, CO₂ sorption cycles for amine-based sorbents can often involve a sorption step that is operated at a temperature between 0° C. and 100° C. The desorption step is then performed at a higher temperature based on the isotherm/isobar for the amine sorbent, such as a temperature of 80° C. to 180° C. In various aspects, the difference between the temperature at the end of the desorption step and the target temperature at the beginning of the sorption step can be 30° C. or more, or 50° C. or more, or 70° C. or more, such as up to 100° C. or possibly still more. Based on this temperature difference, if a CO₂-containing gas is exposed to the sorbent while the sorbent is at or near the temperature from the end of the desorption step, the CO₂ in the CO₂-containing gas will not be adsorbed/absorbed by the sorbent. Instead, such CO₂ will substantially pass through the sorbent environment until the sorbent is cooled sufficiently to allow for CO₂ sorption. Thus, after finishing a desorption step, some type of temperature adjustment step is needed to return the sorbent and/or sorbent environment to roughly the temperature for performing the sorption step, so that CO₂ is not lost unnecessarily while the sorbent is cooling to the appropriate temperature for sorption of CO₂. With regard to pressure, any convenient pressure can be used for sorption and/or desorption.

In various aspects, by using an amine-based sorbent that contains one or more amines with substituted β-carbons, a sorption/desorption cycle can be performed where the temperature adjustment step between the end of desorption and the beginning of sorption can be performed using a temperature adjustment fluid that contains 8.0 vol % or more of 02. Air is an example of a temperature adjustment fluid containing roughly 21 vol % of O₂. Depending on the aspect, the temperature adjustment fluid can have an O₂ content of 8.0 vol % or more, or 10 vol % or more, or 12 vol % or more, or 15 vol % or more, or 20 vol % or more, or 25 vol % or more, such as up to 50 vol % or possibly still higher. In principle, even higher O₂ concentrations (such as up 100 vol %) could be present in a temperature adjustment fluid, but such high purity oxygen streams are typically expensive to create, so it is generally preferred to use air or another lower cost stream. In some aspects, the substitution at the β-carbon can correspond to full substitution on the β-carbon. In some optional aspects, an amine-based sorbent that contains one or more amines with partial substitution on α-carbon and/or one or more amines with replacement substitution at the “beta” location can be used while using air as the fluid for the temperature adjustment step.

In various aspects, the temperature of the gas flow exiting from the sorbent environment at the end of the desorption step can be 60° C. or higher, or 80° C. or higher, or 100° C. or higher, or 120° C. or higher, or 140° C. or higher, or 160° C. or higher, such as up to 180° C. or possibly still higher. A temperature adjustment fluid containing 15 vol % or more of O₂ can then be introduced into the inlet for the sorbent environment. In some aspects, at the start of introducing the temperature adjustment fluid into the sorbent environment, the exhaust temperature for the sorbent environment can differ from the exhaust temperature at the end of the desorption step by 20° C. or less, or 10° C. or less, such as down to having no difference. In other words, if the temperature at the exit from the sorbent environment at the end of the desorption step is 150° C., the temperature at the exit from the sorbent environment at the beginning of the desorption step can be 130° C. or more, or 140° C. or more, such as up to 150° C. It is understood that if there is no gap in time between the end of the desorption step and the start of the flow of the temperature adjustment fluid, then it would be expected that there would be little or no change in the exhaust temperature. Additionally or alternatively, in some aspects, at the start of introducing the temperature adjustment fluid into the sorbent environment, the pressure of the exhaust gas from the sorbent environment can differ from the pressure of the exhaust gas at the end of the desorption step by 5% or less, such as down to having no difference in pressure. In other words, if the exhaust pressure was 100 kPa-a at the end of the desorption step, the exhaust pressure at the start of introducing the temperature adjustment fluid can be 95 kPa-a to 100 kPa-a.

In some aspects, the use of an amine-based sorbent with substituted β-carbons can also be beneficial during a sorption step for sorbing CO₂ from a high CO₂-concentration flow, or for increasing the temperature after a sorption step. First, for gas flows containing CO₂ concentrations of 1.0 vol % or more, some types of sorbents have a high enough enthalpy of adsorption that the sorbent temperature can increase to 70° C. or higher during the sorption step (such as up to 120° C. or possibly still higher). If the gas flow also contains 8.0 vol % or more of O₂ (such as a typical flue gas), use of amines that are substituted at the β-carbon can reduce or minimize degradation of the sorbent. Additionally, substituted amines can be beneficial for resisting degradation after a sorption step as the sorbent heats up to the desorption temperature. It is noted that one conventional option is to simply use steam as the temperature adjustment flow after a sorption process. The same steam can be used for CO₂ desorption as well, so the boundary between the temperature adjustment step and the desorption step may not be well-defined. Using conventional amine-based sorbents, the risk of degradation of the sorbent when introducing steam after the sorption step is simply accepted, leading to reduced operating lifetime for the sorbent bed. By contrast, by using an at least partially β-substituted amine-based sorbent, the potential degradation of the sorbent due to the presence of O₂ while heating the sorbent is reduced or minimized.

It is noted that the target temperature for the beginning of the sorption step may be different from the temperature during the sorption step and/or after the sorption step. For example, the CO₂-containing gas that is exposed to the sorbent during the sorption step will be at a sorbent gas temperature. Often, the CO₂-containing gas will be a flue gas or another gas with a CO₂ concentration of 1.0 vol % or more. At such higher concentrations, the rate of CO₂ sorption by the sorbent can result in sorbent heating during the sorption step, so that the temperature during the sorption step and/or at the end of the sorption step can be higher than the sorbent temperature at the start of the sorption step. By contrast, when performing direct air capture, the sorbent may stay near the sorbent gas temperature during the cycle, as the rate of CO₂ sorption during a direct air capture process can sometimes be slow enough so that the sorbent does not heat up during the sorption step. In fact, if the sorbent is initially at a higher temperature than the sorbent gas temperature during a direct air capture process, there could be a period of cooling at the start of the sorption step as the CO₂-containing gas cools the sorbent.

When performing a sorption/desorption cycle for removal of CO₂ from a CO₂-containing stream, the end points for each step in the cycle can be selected in any convenient manner. Based on the amine sorbent, a target temperature for the start of the sorption step can be selected. The sorption step can be stopped after a fixed time, after a fixed amount of CO₂-containing gas is exposed to the sorbent, after a certain amount of CO₂ breakthrough in the exhaust from the sorbent environment is detected, or based on another convenient metric. If desired, a temperature adjustment step can be performed to increase the temperature of the sorbent to a desorption temperature. Alternatively, such as when steam is used for desorption, the desorption step can be started after the sorption step, with the temperature of the sorbent being increased to the target desorption temperature during the desorption step. The desorption step can be stopped after a fixed time, after a fixed amount of steam has been exposed to the sorbent, after the rate of CO₂ removal drops below a target value, or based on another convenient metric.

### Examples of Sorbent Environment

Any convenient type of sorbent support and/or sorbent environment can be used to perform sorption/desorption of CO₂ using a sorbent based on an amine having a substituted β-carbon. Depending on the nature of the sorbent environment, the amine can be in the form of the amine itself, an amine-containing oligomer or polymer, an amine appended to a metal organic framework material, an amine that is part of a porous liquid, or in another convenient form.

In order to facilitate exposure of the amine to a CO₂-containing gas, the amine can be supported or otherwise formed into a configuration that is stable in the presence of gas flows. One option for supporting an amine is to use a monolith or another type of contactor structure. As an example, a sorbent environment can include one or more monoliths that are designed to provide a large available surface area for contacting a gas flow with surfaces. Some types of monoliths have a plurality of channels passing through the monolith. The channels can be large enough so that a washcoat containing an amine can be coated on the interior surfaces of the channels. Optionally, the amines in the washcoat can be part of a larger compound or composition, such as a metal organic framework material with appended amines. Another option can be to use an amine-containing polymer (where at least a portion of the amines have substituted-carbons) and coat the interiors of channels with a layer of the polymeric material. The monolith itself can be constructed from any convenient material that can support a washcoat or polymeric layer of amine or an amine-containing compound. Examples of monolith materials include refractory oxides (such as alumina), ceramics, and polymers with sufficient structural stability to maintain shape in the presence of the conditions of a sorption/desorption cycle. It is noted that in aspects where the monolith is formed from a polymer, the monolith itself may include amines with substituted β-carbons that can perform sorption/desorption of CO₂. It is further noted that a sufficiently porous monolith may also be able to provide surface area in pores/pore channels of the monolith.

A variation on using a monolith can be to use a 3-D printed structure. Such a 3-D structure can be formed from various types of polymer materials. In some aspects, the 3-D printed structure can serve as a monolith, with an amine added to the surface of the monolith via washcoat or another convenient technique. In other aspects, the 3-D printed structure can have sufficient porosity so that amines incorporated into the volume of the 3-D printed structure can perform CO₂ sorption/desorption. Such amines can be part of the polymer used as the structural material, part of an additional material added to the ink used for making the 3-D printed structure (such as a metal organic framework material that includes appended amines), or a combination thereof.

Still another option can be to support an amine-containing material on objects (such as spheres) that can be used to form a packed bed. This option is similar to using a monolith, but with a reactor designed to allow the CO₂-containing gas to pass through the interstitial gaps between the particles of the packed bed, so that the gas can be exposed to amines supported on the surface/in the pores of the particles of the packed bed.

Yet another option can be to use a hollow fiber contactor. Hollow fibers can be formed from a variety of polymers. The polymer used as the structural material for forming the hollow fiber can include amines with substituted β-carbons, and/or an additional amine-containing material can be incorporated into the hollow fiber structure, such as a metal organic framework material with appended amines.

It is noted that for configurations where amines are appended to a material, such as a metal organic framework material, the amines can be appended at any convenient time. Thus, amines could be appended to a metal organic framework material after forming a contactor structure.

Still another option can be to use amines in the form of a porous liquid. The amines can correspond to a porous liquid supported in a porous liquid contactor. Examples of porous liquids and porous liquid contactors are described, for example, in U.S. Patent Application Publication 2020/0147543, U.S. Patent Application Publication 2020/0147545, and U.S. Patent Application Publication 2020/0147519, each of which are incorporated herein by reference for the limited purpose of describing a porous liquid and a porous liquid contactor structure.

### Example 1—Determination of CO₂ Capacities after Air Exposure

As described above, various prior literature studies regarding stability of amines with unsubstituted β-carbons have found that amines are susceptible to degradation during air exposure at temperatures of 70° C. or higher. To investigate the resistance to stability provided by using amines with fully substituted β-carbons, CO₂ capacities of two amine-based sorbents were determined after exposure to air at various temperatures. The amine-based sorbents corresponded to amine-appended versions of EMM-67. EMM-67 is a mixed-metal version of a metal organic framework composition having the MOF-274 structure. EMM-67 includes a mixture of Mn and Mg as the metals in the MOF-274-type structure. EMM-67 is described, for example, in international publication WO 2020/219907. EMM-44 is an amine-appended version of EMM-67. Based on the nature of MOF-274-type structures, amines can be appended to the metal organic framework to form amine-appended compositions.

Samples of EMM-67 were appended with two types of amines. One group of EMM-67 samples was appended with the “3-3-3” tetraamine shown in FIG. 1, which has the IUPAC name N¹,N¹′-(propane-1,3,-diyl)bis(propane-1,3-diamine). “3-3-3” tetraamine includes two primary amines and two secondary amines. Appending EMM-67 with “3-3-3” tetraamine corresponds to the material EMM-53 (3-3-3). It is noted that “3-3-3” tetraamine has 3 β-carbon sites that are not substituted (i.e., “3-3-3” tetraamine includes 3 β-carbon sites, with each β-carbon including two bonds to hydrogen atoms).

Another group of samples was appended with 2,2-dimethylpropane-1,3-diamine (abbreviation “dmpn”). As illustrated in FIG. 1, dmpn includes two primary amines and one β-carbon site. That β-carbon site is fully substituted by the two methyl groups attached to the β-carbon. Appending EMM-67 with dmpn results in the material EMM-47.

The following procedure was used to determine CO₂ sorption isobars for the various samples. Isobaric TGA sorption data (CO₂ isobars) was collected on a Mettler TGA/DSC1 instrument using a 100% CO₂ feed. Samples were loaded into the chamber and pre-treated by heating to 140° C. at 4° C./min under 50 cc/min N₂ flow and subjected to isothermal hold at 140° C. for 2 hours. Subsequently, the gas was switched to 100 cc/min CO₂ flow with the temperature maintained at 140° C. for 30 min. The samples were then cooled at 1° C./min to 18° C. under CO₂ flow and then held at 18° C. for 4 hours under CO₂ flow to allow for adsorption equilibration. The samples were then ramped to 140° C. at 1° C./min under CO₂ flow and held for 1 hour to determine desorption. Adsorption and Desorption weights were adjusted using the post-N2-pretreatment sample weights to determine the adsorption and desorption CO₂ capacities.

First, the CO₂ capacity of an EMM-47 sample (fully substituted β-carbon) was tested prior to exposure to air at elevated temperature. Based on exposure of the EMM-47 to 100% CO₂ at elevated temperature, the CO₂ capacity of the EMM-47 was determined to be roughly 4.07 mmol/g (i.e., 4.07 mmol CO₂/g MOF) prior to exposure to air.

The EMM-53 (3-3-3) and EMM-47 samples (including the appended amines) were then exposed to air at elevated temperatures, after which their CO₂ capacity was studied by measuring the 100% CO₂ isobar. For the exposure to air, samples were exposed to flowing air with ambient humidity at a temperature between 100° C. and 180° C. for a period of roughly 24 hours.

CO₂ isobars for EMM-47 samples (fully substituted β-carbon) were obtained after exposure to air at temperatures of 100° C., 120° C., 130° C., 140° C., 150° C., 160° C., 170° C., and 180° C. Table 1 shows the CO₂ capacities that were calculated based on the measured CO₂ isobars. The capacity from exposure to CO₂ prior to exposure to air is also included for comparison. The capacities are in mmol CO₂ per gram of MOF.

TABLE 1
EMM-47 CO₂ Capacities

| | Calculated CO₂ Capacity (from |
|---|---|
| Temperature of Air Exposure | measured isobar) |
| None | 4.07 mmol/g |
| 100° C. | 4.01 mmol/g |
| 120° C. | 4.13 mmol/g |
| 140° C. | 4.07 mmol/g |
| 150° C. | 3.88 mmol/g |
| 160° C. | 4.13 mmol/g |
| 170° C. | 3.98 mmol/g |
| 180° C. | 2.98 mmol/g |

As shown in Table 1, determining the CO₂ capacity from measuring the isobar has some inherent uncertainty. Thus, it is believed that all of the CO₂ capacity values from air exposure at 100° C. to 170° C. are substantially the same as the CO₂ capacity for a sample prior to any air exposure. This is unexpected, as it is conventionally believed that amine-based sorbents are degraded by air exposure at temperatures well below 170° C. By contrast, after air exposure at 180° C. for 24 hours, it appears that a statistically significant reduction in CO₂ capacity occurs. This demonstrates that the EMM-47 samples, which include an amine that is fully substituted on the β-carbon, showed no apparent loss of CO₂ capacity after exposure to air at temperatures up to 170° C.

Samples of EMM-53 (including 3-3-3 tetraamine, which contains unsubstituted β-carbons) were also exposed to flowing humid air followed by measurement of CO₂ isobars to determine CO₂ capacity. The samples were exposed to air at temperatures of 100° C. (line 400), 110° C. (line 410), 120° C. (line 420), and 140° C. (line 440). Table 2 summarizes the results for the CO₂ capacities calculated based on the isobars.

TABLE 2
EMM-53(3-3-3) CO₂ Capacities

| | Calculated CO₂ Capacity (from |
|---|---|
| Temperature of Air Exposure | measured isobar) |
| 100° C. | 4.08 mmol/g |
| 110° C. | 4.07 mmol/g |
| 120° C. | 3.07 mmol/g |
| 140° C. | 3.42 mmol/g |

As shown in Table 2, the CO₂ capacity of the EMM-53 (3-3-3) samples was similar for the samples exposed to air at 110° C. or less. However, at 120° C. and 140° C., a substantial reduction in CO₂ capacity was observed. Again, the exact magnitude of the reduction in capacity is not clear due to the nature of determining CO₂ capacity based on a measured isobar. However, the drop in CO₂ capacity is clearly large enough to show that some type of degradation of the amine occurs after exposure to air at 120° C. or more. It is further noted that the amines appended to the EMM-53 (3-3-3) are heavier than the amines appended to EMM-47. However, the EMM-53 (3-3-3) experienced degradation at lower temperatures than the EMM-47. Thus, the difference in degradation is not a volatility issue due to differences in molecular weight.

Based on the data in Table 1 and Table 2, substitution of the hydrogens on the β-carbon in the propyl diamine-type structures (EMM-47) provided a clear and unexpected stability advantage relative to the unsubstituted propylene diamine-type structures in EMM-53 (3-3-3). The next example will illustrate a similar benefit in ethylene diamine type structures.

### Example 2—CO₂ Capacity and Stability with Variations in Substitution

Additional samples of amine appended MOFs were formed and used to investigate variations in the amount of substitution on the β-carbon of an amine. The MOF used was EMM-50. Samples of EMM-50 were prepared with three different types of appended diamines. The structures of the three diamines used in this example are shown in FIG. 2. A first type of sample used ethylene diamine, (no β-substitution). This is referred to herein as EMM-50(en). A second type of sample used methyl-substituted ethylene diamine, so that one methyl is added to one of the carbons. This is referred to herein as EMM-50 (men), and corresponds to partial substitution on a β-carbon. The third type of sample used dimethyl-substituted ethylene diamine, with both methyls being substituted on the same carbon. This is referred to herein as EMM-50(den). This corresponds to full substitution of a β-carbon. It is noted that due to the structure of ethylene diamine, addition of a methyl group to a β-carbon results in partial substitution, but also results in creation of an additional β-carbon. Thus, for (den) where one β-carbon is fully substituted with methyl groups, the additional methyl groups both correspond to additional-carbons. The results below show that stabilization is provided by substitution even when the substitution on a β-carbon results in creation of more β-carbons.

It is noted that due to the structure of ethylene diamine, both carbon atoms are in an “alpha” position relative to one amine and in a “beta” position relative to the other. However, it is believed that the benefits of protection against oxygen exposure at temperature shown herein are representative. Also, it is further noted that for EMM-50(den), although hydrogens are present on one carbon that could be a β-carbon, there is not an elimination mechanism for those hydrogens due to the full substitution on the other carbon. In other words, elimination of a hydrogen on a β-carbon would normally involve formation of an olefinic bond. However, in EMM-50(den), the adjacent carbon is a quaternary carbon, and therefore there is no availability to form an olefinic bond.

Table 3 shows the CO₂ capacities from measured isobars for EMM-50 (en) (no substitution) after exposure to air at 100° C., 120° C., 140° C., and 160° C. As shown in Table 3, the ethylene diamine is relatively stable at temperatures up to 120° C. After the exposure period at 140° C., the capacity for CO₂ sorption started to drop. After exposure at 160° C., more than half of the sorption capacity has been lost. It is noted that the exposure times used to generate the data still represent relatively short operating lifetimes. Thus, it can be seen that relatively rapid degradation of the amine occurs when no substitution is present on a β-carbon.

TABLE 3
EMM-50(en) CO₂ Capacities

| | Calculated CO₂ Capacity (from |
|---|---|
| Temperature of Air Exposure | measured isobar) |
| As Synthesized | 4.33 mmol/g |
| 100° C. | 4.29 mmol/g |
| 120° C. | 4.22 mmol/g |
| 140° C. | 3.76 mmol/g |
| 160° C. | 1.49 mmol/g |

Table 4 shows CO₂ capacities from measured isobars for the EMM-50 (men) samples after exposure to air at the same temperatures. As shown in Table 4, partial substitution of a β-carbon provided unexpectedly improved stability, as no degradation was seen after exposure to air at 140° C. Exposure to air at 160° C. resulted in some loss in CO₂ capacity, but the loss was not as severe as the loss observed for the unsubstituted amine.

TABLE 4
EMM-50(men) CO₂ Capacities

| | Calculated CO₂ Capacity (from |
|---|---|
| Temperature of Air Exposure | measured isobar) |
| As Synthesized | 4.29 mmol/g |
| 100° C. | 4.17 mmol/g |
| 120° C. | 4.17 mmol/g |
| 140° C. | 4.05 mmol/g |
| 160° C. | 2.99 mmol/g |

Table 5 shows CO₂ capacities from measured isobars for the EMM-50(den) samples after exposure to air at the same temperatures. First, it is noted that fully substituting one of the β-carbons resulted in a lowering of CO₂ capacity prior to any air exposure. However, fully substituting one of the β-carbons resulted in an amine that unexpectedly retained substantially all of its CO₂ capacity independent of the temperature of exposure up to 160° C. Even at lower total capacity, it is commercially valuable to have a process that operates with high stability over long periods of time.

TABLE 5
EMM-50(den) CO₂ Capacities

| | Calculated CO₂ Capacity (from |
|---|---|
| Temperature of Air Exposure | measured isobar) |
| As Synthesized | 2.80 mmol/g |
| 100° C. | 2.53 mmol/g |
| 120° C. | 2.49 mmol/g |
| 140° C. | 2.50 mmol/g |
| 160° C. | 2.42 mmol/g |

It is noted that the fully substituted EMM-47 samples in Example 1 did not have a similar loss of capacity due to full substitution of a β-carbon.

### Additional Embodiments

Embodiment 1. A method for performing cyclic sorption and desorption of CO₂, comprising: contacting an amine-based sorbent with a CO₂-containing input flow to form a CO₂-loaded sorbent and a sorption output flow with a CO₂ content lower than the CO₂-containing input flow, the amine-based sorbent comprising one or more amines having a substituted β-carbon; desorbing CO₂ from the sorbent by exposing the CO₂-loaded sorbent to a desorption input flow to form a CO₂-depleted sorbent and a desorption output flow with a CO₂ content greater than the desorption input flow, a temperature of the desorption output flow at the end of the desorbing being 80° C. or higher; adjusting the temperature of the sorbent by exposing the sorbent to a temperature adjustment flow comprising 8.0 vol % or more of O₂ to form a regenerated sorbent and an adjustment output flow, a temperature of the adjustment output flow at an end of the adjusting being lower than the temperature at the end of the desorbing by 20° C. or more.

Embodiment 2. The method of Embodiment 1, wherein the amine-based sorbent comprises a regenerated sorbent from a prior cycle.

Embodiment 2. The method of Embodiment 1, wherein the temperature of the adjustment output flow at the beginning of the adjusting is within 20° C. of the temperature of the desorption output flow at the end of the desorbing.

Embodiment 3. The method of any of the above embodiments, wherein the temperature of the adjustment output flow at the beginning of the adjusting is 80° C. or higher.

Embodiment 4. The method of any of the above embodiments, wherein the sorption output flow has a first temperature at an end of the contacting, the first temperature being less than the temperature of the desorption output flow at the end of the desorbing by 30° C. or more.

Embodiment 5. The method of any of the above embodiments, wherein the CO₂-containing stream comprises 1.0 vol % or more of CO₂.

Embodiment 6. The method of Embodiment 5, wherein the CO₂-containing stream comprises 8.0 vol % or more of 02, or wherein the sorption output flow has a first temperature at an end of the contacting of 70° C. or more, or a combination thereof.

Embodiment 7. The method of any of Embodiments 1-4, wherein the CO₂-containing stream comprises less than 1.0 vol % of CO₂, the sorption output flow optionally having a first temperature at an end of the contacting of 0° C. to 50° C.

Embodiment 8. The method of any of the above embodiments, wherein at least a portion of the one or more amines have a fully substituted-carbon, or wherein at least a portion of the one or more amines have a partially substituted β-carbon, or wherein at least a portion of the one or more amines have a replacement substitution of the β-carbon, or a combination thereof.

Embodiment 9. The method of any of the above embodiments, wherein at least a portion of the one or more amines having a substituted β-carbon comprise a β-carbon bonded to at least one of an oxygen atom and a halogen atom, or wherein the one or more amines comprise at least one primary amine, or a combination thereof.

Embodiment 10. The method of any of the above embodiments, wherein the temperature of the desorption output flow at the end of the desorbing is 120° C. or higher.

Embodiment 11. The method of any of the above embodiments, wherein the one or more amines comprise at least one primary amine and at least one secondary amine.

Embodiment 12. The method of any of the above embodiments, wherein the amine-based sorbent comprises an amine-containing polymer, or wherein the amine-based sorbent comprises one or more amines appended to a metal-organic framework, or a combination thereof.

Embodiment 13. The method of any of the above embodiments, wherein the amine-based sorbent is supported on at least one of a monolith, particles of a packed bed, a hollow fiber, or a combination thereof.

Embodiment 14. The method of any of the above embodiments, wherein the desorption input flow comprises steam.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A method for performing cyclic sorption and desorption of CO₂, comprising:
contacting an amine-based sorbent with a CO₂-containing input flow to form a CO₂-loaded sorbent and a sorption output flow with a CO₂ content lower than the CO₂-containing input flow, the amine-based sorbent comprising one or more amines having a substituted β-carbon;
desorbing CO₂ from the sorbent by exposing the CO₂-loaded sorbent to a desorption input flow to form a CO₂-depleted sorbent and a desorption output flow with a CO₂ content greater than the desorption input flow, a temperature of the desorption output flow at the end of the desorbing being 80° C. or higher;
adjusting the temperature of the sorbent by exposing the sorbent to a temperature adjustment flow comprising 8.0 vol % or more of O₂ to form a regenerated sorbent and an adjustment output flow, a temperature of the adjustment output flow at an end of the adjusting being lower than the temperature at the end of the desorbing by 20° C. or more.

2. The method of claim 1, wherein the temperature of the adjustment output flow at the beginning of the adjusting is within 20° C. of the temperature of the desorption output flow at the end of the desorbing.

3. The method of claim 1, wherein the temperature of the adjustment output flow at the beginning of the adjusting is 80° C. or higher.

4. The method of claim 1, wherein the sorption output flow has a first temperature at an end of the contacting, the first temperature being less than the temperature of the desorption output flow at the end of the desorbing by 30° C. or more.

5. The method of claim 1, wherein the CO₂-containing stream comprises 1.0 vol % or more of CO₂.

6. The method of claim 5, wherein the CO₂-containing stream comprises 8.0 vol % or more of O₂.

7. The method of claim 5, wherein the sorption output flow has a first temperature at an end of the contacting of 70° C. or more.

8. The method of claim 1, wherein the CO₂-containing stream comprises less than 1.0 vol % of CO₂.

9. The method of claim 8, wherein the sorption output flow has a first temperature at an end of the contacting of 0° C. to 50° C.

10. The method of claim 1, wherein at least a portion of the one or more amines have a fully substituted β-carbon.

11. The method of claim 1, wherein at least a portion of the one or more amines have a partially substituted β-carbon, or wherein at least a portion of the one or more amines have a replacement substitution of a β-carbon, or a combination thereof.

12. The method of claim 1, wherein at least a portion of the one or more amines having a substituted β-carbon comprise a β-carbon bonded to at least one of an oxygen atom or a halogen atom.

13. The method of claim 1, wherein the one or more amines comprise at least one primary amine.

14. The method of claim 1, wherein the temperature of the desorption output flow at the end of the desorbing is 120° C. or higher.

15. The method of claim 1, wherein the one or more amines comprise at least one primary amine and at least one secondary amine.

16. The method of claim 1, wherein the amine-based sorbent comprises an amine-containing polymer.

17. The method of claim 1, wherein the amine-based sorbent is supported on at least one of a monolith, particles of a packed bed, a hollow fiber, or a combination thereof.

18. The method of claim 1, wherein the amine-based sorbent comprises one or more amines appended to a metal-organic framework.

19. The method of claim 1, wherein the desorption input flow comprises steam.

20. The method of claim 1, wherein the amine-based sorbent comprises a regenerated sorbent from a prior cycle.
